(19) United States
(12) Patent Application Publication
(10) Pub. No.: US 2010/0215955 A1
(43) Pub. Date: Aug. 26, 2010

(54) PRESSURE-SENSITIVE ADHESIVE SHEET AND PRESSURE-SENSITIVE ADHESIVE FUNCTIONAL FILM

(75) Inventor: Hiroaki KISHIOKA, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/711,538

(22) Filed: Feb. 24, 2010

(30) Foreign Application Priority Data
Feb. 25, 2009 (JP) 2009-043078

(51) Int. Cl. B32B 7/12; B32B 27/30; C09J 7/00; C08F 220/06

(52) U.S. Cl. 428/355 AC; 526/318.5

(57) ABSTRACT

The present invention provides a pressure-sensitive adhesive sheet including at least one pressure-sensitive adhesive layer formed of a pressure-sensitive adhesive composition containing an acrylic polymer (a) in which the total content of acrylic acid and methacrylic acid relative to the entire monomer ingredients constituting the acrylic polymer is 10% by weight or less, in which the total amount of an acrylic acid ion and a methacrylic acid ion extracted from the pressure-sensitive adhesive sheet with pure water under the condition of 100° C. for 45 minutes, as measured in accordance with an ion chromatography, is 20 ng/cm² or less per the unit area of the pressure-sensitive adhesive layer.

### FIELD OF THE INVENTION

The present invention relates to a pressure-sensitive adhesive sheet. Precisely, the invention relates to a pressure-sensitive adhesive sheet which does not cause corrosion of metal thin films or metal oxide thin films and is favorable for use to be stuck to metal thin films or metal oxide thin films.

### BACKGROUND OF THE INVENTION

Recently, display devices such as liquid-crystal displays (LCD) and input devices to be combined with the display devices such as touch panels have become widely used in various fields. In producing such display devices and input devices, transparent pressure-sensitive adhesive sheets are used for bonding parts (optical parts) such as transparent plastic substrates (e.g., polycarbonate substrates, acrylic resin substrates) and optical films of polarizers, etc. In these applications, the pressure-sensitive adhesive sheets are required to be transparent and are further required to have excellent reliability such as resistance to foaming and peeling even in high-temperature high-humidity environments (foaming/peeling resistance). For example, transparent double-sided pressure-sensitive adhesive sheets are used for bonding touch panels and various display devices and optical parts (e.g., protective plates) (for example, see Patent References 1 to 3).

Heretofore, as a pressure-sensitive adhesive sheet with improved foaming/peeling resistance, known is a pressure-sensitive adhesive sheet having a pressure-sensitive adhesive layer formed of an pressure-sensitive adhesive composition that contains an acrylic polymer and an acrylic oligomer comprising a carboxyl group-containing monomer such as acrylic acid as the monomer ingredient thereof (for example, see Patent Reference 4).

On the other hand, for use in production of a capacitance type touch panel, a pressure-sensitive adhesive sheet may be directly stuck to a metal thin film or a metal oxide thin film such as ITO (indium tin oxide) film (hereinafter metal thin film and metal oxide thin film may be generically referred to as “metal thin film”). In such use, the pressure-sensitive adhesive sheet is further required not to corrode the metal thin film, or that is, required to have resistance to corrosion.

However, in case where the pressure-sensitive adhesive sheet as above that comprises an acrylic polymer or the like composed of a carboxyl group-containing monomer as the monomer ingredient thereof is stuck to a metal thin film and when this is stored under high-humidity condition, then there occurs a problem in that the resistance value of the metal thin film changes, or that is, the metal tin film is corroded.

Accordingly, regarding the pressure-sensitive adhesive sheet as above that comprises an acrylic polymer composed of a carboxyl group-containing monomer such as acrylic acid as the monomer ingredient thereof, at present, no one has succeeded in obtaining a pressure-sensitive adhesive sheet satisfying the resistance to corrosion of metal thin films (hereinafter this may be simply referred to as “resistance to corrosion”)

Patent Reference 1: JP-A 2003-238915

Patent Reference 2: JP-A 2003-342542

Patent Reference 3: JP-A 2004-231723

Patent Reference 4: Japanese Patent No. 3907611

### SUMMARY OF THE INVENTION

An object of the invention is to provide a pressure-sensitive adhesive sheet having a pressure-sensitive adhesive layer formed of an acrylic polymer comprising acrylic acid and/or methacrylic acid as the monomer ingredient thereof, which is excellent in corrosion resistance.

The present inventors have assiduously studied for the purpose of attaining the above-mentioned object and, as a result, have found that, when the total amount of the acrylic acid and methacrylic acid ions extracted from the pressure-sensitive adhesive sheet in boiling extraction thereof, or that is, the total amount of the acrylic acid and methacrylic acid ions contained in the pressure-sensitive adhesive layer and liberated with water is controlled to a predetermined level or less, then a pressure-sensitive adhesive sheet excellent in corrosion resistance can be obtained, and have completed the present invention.

Namely, the present invention provides the following items 1 to 8.

1. A pressure-sensitive adhesive sheet comprising at least one pressure-sensitive adhesive layer formed of a pressure-sensitive adhesive composition containing an acrylic polymer (a) in which the total content of acrylic acid and methacrylic acid relative to the entire monomer ingredients constituting the acrylic polymer is 10% by weight or less, wherein the total amount of an acrylic acid ion and a methacrylic acid ion extracted from the pressure-sensitive adhesive sheet with pure water under the condition of 100° C. for 45 minutes, as measured in accordance with an ion chromatography, is 20 ng/cm² or less per the unit area of the pressure-sensitive adhesive layer.

2. The pressure-sensitive adhesive sheet according to item 1, wherein the pressure-sensitive adhesive composition contains the following acrylic oligomer (b) in an amount of from 10 to 35 parts by weight relative to 100 parts by weight of the following acrylic polymer (a),

the acrylic polymer (a) being an acrylic polymer comprising an alkyl (meth)acrylate in which the alkyl group has from 4 to 12 carbon atoms, and/or an alkoxyalkyl(meth)acrylate as the main monomer ingredient, and acrylic acid and/or methacrylic acid as an indispensable monomer ingredient, in which the total content of the acrylic acid and the methacrylic acid relative to the entire monomer ingredients constituting the acrylic polymer is from 2.5 to 10% by weight, the acrylic polymer (a) having a weight-average molecular weight of from 500,000 to 900,000, and

the acrylic oligomer (b) being an acrylic oligomer comprising a (meth)acrylate which has a cyclic structure in the molecule thereof and of which the homopolymer has a glass transition temperature of from 60 to 190° C., as the main monomer ingredient, and acrylic acid and/or methacrylic acid as an indispensable monomer ingredient, in which the total content of the acrylic acid and the methacrylic acid relative to the entire monomer ingredients constituting the acrylic oligomer is from 2.5 to 10% by weight, the acrylic oligomer (b) having a weight-average molecular weight of 3,000 or more but less than 6,000.

3. The pressure-sensitive adhesive sheet according to item 2, wherein the acrylic polymer (a) and the acrylic oligomer (b) respectively are an acrylic polymer and an acrylic oligomer prepared in accordance with a solution polymerization method or an emulsion polymerization method.

4. The pressure-sensitive adhesive sheet according to item 2,

wherein the acrylic polymer (a) is an acrylic polymer comprising the acrylic acid as an indispensable monomer ingredient, in which the content of the acrylic acid relative to the entire monomer ingredients constituting the acrylic polymer is from 2.5 to 10% by weight,

wherein the acrylic oligomer (b) is an acrylic oligomer comprising the acrylic acid as an indispensable monomer ingredient, in which the content of the acrylic acid relative to the entire monomer ingredient constituting the acrylic oligomer is from 2.5 to 10% by weight, and

wherein the amount of the acrylic acid ion extracted from the pressure-sensitive adhesive sheet with pure water at 100° C. for 45 minutes, as measured in accordance with an ion chromatography, is 20 ng/cm² or less per the unit area of the pressure-sensitive adhesive layer.

5. The pressure-sensitive adhesive sheet according to item 1, which is a substrate-less pressure-sensitive adhesive sheet having no substrate.

6. The pressure-sensitive adhesive sheet according to item 1, which is for use in an application of being stuck to a metal thin film or a metal oxide thin film.

7. The pressure-sensitive adhesive sheet according to item 1, which is a pressure-sensitive adhesive sheet for touch panel for use in a production of a touch panel.

8. A pressure-sensitive adhesive functional film comprising a functional film and the pressure-sensitive adhesive sheet according to item 1 laminated on at least one surface of the functional film; the pressure-sensitive adhesive sheet being a double-sided pressure-sensitive adhesive sheet.

In the pressure-sensitive adhesive sheet of the invention, since acrylic acid and/or methacrylic acid is/are used as the monomer ingredient(s) of the acrylic polymer constituting the pressure-sensitive adhesive layer, the pressure-sensitive adhesive sheet is excellent in adhesiveness. Accordingly, when used for bonding of optical parts in displays, the optical properties such as the visibility of the products can be enhanced. Further, when stuck to a metal thin film, the sheet does not corrode the metal thin film, and therefore, the sheet is favorable for use to be stuck to a transparent electroconductive film on which a metal thin film of ITO (indium tin oxide) or the like is formed.

### BRIEF DESCRIPTION OF THE DRAWINGS

FIG. 1 is a schematic cross-sectional view showing one example of a laminate of a functional film (hard coat film) and an ITO film with a pressure-sensitive adhesive sheet of the invention used therein.

FIG. 2 is a schematic view (plan view) showing a sample for resistance measurement, used in evaluation of corrosion resistance in Examples.

### DESCRIPTION OF REFERENCE NUMERALS AND SIGNS

11 ITO film
12 pressure-sensitive adhesive sheet of the Invention
13 functional film (hard coat PET film)
14 pressure-sensitive adhesive functional film
21 test piece
22 electroconductive PET film (exposed part of ITO film-coated face)
23 electroconductive PET film (silver paste-coated part)

### DETAILED DESCRIPTION OF THE INVENTION

The pressure-sensitive adhesive sheet of the invention includes at least one pressure-sensitive adhesive layer (acrylic pressure-sensitive adhesive layer) (hereinafter this may be referred to as “pressure-sensitive adhesive layer of the invention”) formed of a pressure-sensitive adhesive composition containing an acrylic polymer (a) in which the total content of acrylic acid and methacrylic acid relative to the entire monomer ingredients constituting the acrylic polymer is 10% by weight or less. The pressure-sensitive adhesive layer of the invention is preferably formed of a pressure-sensitive adhesive composition containing an acrylic oligomer (b) as an essential ingredient to be mentioned below, in addition to the acrylic polymer (a).

The pressure-sensitive adhesive sheet of the invention may be a double-sided pressure-sensitive adhesive sheet of which the two faces are pressure-sensitive adhesive faces (pressure-sensitive adhesive layer surfaces), or a single-sided pressure-sensitive adhesive sheet of which one face alone is a pressure-sensitive adhesive face. Above all, preferred is a double-sided pressure-sensitive adhesive sheet from the viewpoint of bonding two parts to each other with it. In the invention, “pressure-sensitive adhesive sheet” includes a tape-like one, or that is, “pressure-sensitive adhesive tape”.

The pressure-sensitive adhesive sheet of the invention may be a so-called “substrate-less type” pressure-sensitive adhesive sheet having no substrate (substrate layer) (hereinafter this may be referred to as “substrate-less pressure-sensitive adhesive sheet”), or a substrate-having pressure-sensitive adhesive sheet. The substrate-less pressure-sensitive adhesive sheet may be a pressure-sensitive adhesive sheet formed only of the pressure-sensitive adhesive layer of the invention, or may be a pressure-sensitive adhesive sheet including the pressure-sensitive adhesive layer of the invention and any other pressure-sensitive adhesive layer than the pressure-sensitive adhesive layer of the invention (hereinafter this may be referred to as “other pressure-sensitive adhesive layer”). The substrate-having pressure-sensitive adhesive sheet may have the pressure-sensitive adhesive layer of the invention on at least one face of the substrate therein. Above all, from the viewpoint of reducing the thickness of the pressure-sensitive adhesive sheet and enhancing the optical properties such as the transparency thereof, preferred is the substrate-less pressure-sensitive adhesive sheet (substrate-less double-sided pressure-sensitive adhesive sheet), and more preferred is the substrate-less double-sided pressure-sensitive adhesive sheet formed only of the pressure-sensitive adhesive layer of the invention. The above-mentioned “substrate (substrate layer)” does not include a release liner (separator) to be released before use of the pressure-sensitive adhesive sheet (for bonding).

### Pressure-Sensitive Adhesive Layer of the Invention

The above-mentioned pressure-sensitive adhesive layer of the invention is a pressure-sensitive adhesive layer (acrylic pressure-sensitive adhesive layer) formed of a pressure-sensitive adhesive composition (acrylic pressure-sensitive adhesive composition) containing an acrylic polymer (a) mentioned below as an indispensable ingredient thereof. The pressure-sensitive adhesive composition preferably contains an acrylic oligomer (b) to be mentioned below as another indispensable ingredient thereof, in addition to the acrylic polymer (a), and may further contain, if desired, any other ingredients (e.g., additives).

### (Acrylic Polymer (a))

The acrylic polymer (a) in the invention is a polymer containing acrylic acid and/or methacrylic acid as an indispensable monomer ingredient (that is, containing at least one of acrylic acid and methacrylic acid as an indispensable monomer ingredient). Especially preferred is a polymer containing acrylic acid as the indispensable monomer ingredient. Not specifically defined, the acrylic polymer (a) is preferably a polymer containing an alkyl(meth)acrylate in which the alkyl group has from 4 to 12 carbon atoms (hereinafter this may be referred to as “C₄₋₁₂ alkyl(meth)acrylate”) and/or an alkoxyalkyl(meth)acrylate as the main monomer ingredient (main monomer ingredient), and acrylic acid and/or methacrylic acid ((meth)acrylic acid) as an indispensable monomer ingredient. The monomer ingredients constituting the acrylic polymer (a) may further include, if desired, any other monomer ingredient (comonomer), in addition to the above-mentioned C₄₋₁₂ alkyl(meth)acrylate, alkoxyalkyl(meth)acrylate and (meth)acrylic acid. “(Meth)acryl” means “acryl” and/or “methacryl”, and the same shall apply hereinunder.

The C₄₋₁₂ alkyl(meth)acrylate in the acrylic polymer (a) is an alkyl (meth)acrylate (alkyl acrylate and/or alkyl methacrylate) in which the alkyl group is a linear or branched alkyl group having from 4 to 12 carbon atoms, and includes, for example, n-butyl(meth)acrylate, isobutyl(meth)acrylate, s-butyl(meth)acrylate, t-butyl (meth)acrylate, pentyl(meth)acrylate, isopentyl(meth)acrylate, neopentyl (meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, isononyl (meth)acrylate, decyl(meth)acrylate, isodecyl(meth)acrylate, undecyl(meth)acrylate, dodecyl(meth)acrylate, etc. As the C₄₋₁₂ alkyl(meth)acrylate, especially preferred is n-butyl(meth)acrylate. The above-mentioned C₄₋₁₂ alkyl(meth)acrylates may be used either singly or as combined.

Not specifically defined, the alkoxyalkyl(meth)acrylate in the acrylic polymer (a) includes, for example, 2-methoxyethyl(meth)acrylate, 2-ethoxyethyl(meth)acrylate, methoxytriethylene glycol (meth)acrylate, 3-methoxypropyl(meth)acrylate, 3-ethoxypropyl(meth)acrylate, 4-methoxybutyl(meth)acrylate, 4-ethoxybutyl (meth)acrylate, etc. These alkoxyalkyl(meth)acrylates may be used either singly or as combined. Above all, preferred is an alkoxyalkyl acrylate, and more preferred is 2-methoxyethyl acrylate (2MEA).

The content of the above-mentioned main monomer ingredient [C₄₋₁₂ alkyl (meth)acrylate and/or alkoxyalkyl(meth)acrylate] relative to the entire monomer ingredients (total amount of the monomer ingredients) (100% by weight) constituting the acrylic polymer (a) is preferably 50% by weight or more, more preferably 80% by weight or more, even more preferably 90% by weight or more, since this ingredient is the main monomer ingredient. The uppermost limit of the content of the main monomer ingredient relative to the entire monomer ingredient is preferably 99% by weight or less, more preferably 97% by weight or less, since the monomer ingredients contain at least (meth)acrylic acid an the indispensable monomer ingredient. In case where both a C₄₋₁₂ alkyl(meth)acrylate and an alkoxyalkyl acrylate are used as the monomer ingredients, then the total (total content) of the content of the C₄₋₁₂ alkyl (meth)acrylate and the content of the alkoxyalkyl acrylate may satisfy the above range.

The monomer ingredients constituting the acrylic polymer (a) contain (meth)acrylic acid. The total content of acrylic acid and methacrylic acid relative to the entire monomer ingredients (total amount of the monomer ingredients) (100% by weight) constituting the acrylic polymer (a) is 10% by weight or less (for example, from 0.1 to 10% by weight), preferably from 2.5 to 10% by weight, more preferably from 3 to 10% by weight, even more preferably from 3 to 7% by weight. When the total content of acrylic acid and methacrylic acid is more than 10% by weight, then the total amount of the acrylic acid ion and the methacrylic acid ion extracted with pure water under the condition of 100° C. for 45 minutes from the pressure-sensitive adhesive sheet of the invention (hereinafter this may be referred to as “extracted (meth)acrylic acid ion amount”) could not be controlled to be 20 ng/cm² or less. On the other hand, when the total content of acrylic acid and methacrylic acid is small or is 0% by weight, then the pressure-sensitive adhesiveness of the pressure-sensitive adhesive sheet to objects may tend to lower. In particular, in case where the acrylic polymer (a) is a polymer containing acrylic acid as an indispensable monomer ingredient thereof, the acrylic acid content preferably satisfies the above range.

In the acrylic polymer (a), if desired, any other monomer ingredient (copolymerizable monomer) copolymerizable with the C₄₋₁₂ alkyl(meth)acrylate, the alkoxyalkyl(meth)acrylate and (meth)acrylic acid may be used as a monomer ingredient constituting the acrylic polymer (a) in combination thereto. The copolymerizable monomer content (total content of the entire copolymerizable monomers) relative to the entire monomer ingredients (total amount of the monomer ingredients) (100% by weight) constituting the acrylic polymer (a) may be suitably selected depending on the type of the copolymerizable monomer and is therefore not specifically defined; but preferably, the copolymerizable monomer content is 49.9% by weight or less (from 0 to 49.9% by weight).

The copolymerizable monomer for the acrylic polymer (a) includes, for example, C₁₋₃ alkyl(meth)acrylates such as methyl(meth)acrylate, ethyl(meth)acrylate, propyl(meth)acrylate, isopropyl(meth)acrylate, etc.; C₁₃₋₂₀ alkyl(meth)acrylates such as tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, eicosyl(meth)acrylate, etc.; non-aromatic ring-containing (meth)acrylates such as cycloalkyl(meth)acrylates [e.g., cyclohexyl(meth)acrylate], isobornyl(meth)acrylate, etc.; aromatic ring-containing (meth)acrylates such as aryl (meth)acrylates [e.g., phenyl(meth)acrylate], aryloxyalkyl(meth)acrylates [e.g., phenoxyethyl(meth)acrylate], arylalkyl(meth)acrylates [e.g., benzyl(meth)acrylate], etc.; carboxyl group-having monomers except acrylic acid and methacrylic acid, such as itaconic acid, maleic acid, fumaric acid, crotonic acid, etc., and acid anhydrides of these carboxyl group-having monomers (e.g., acid anhydride group-having monomers such as maleic anhydride, itaconic anhydride); epoxy group-having acrylic monomers such as glycidyl(meth)acrylate, methylglycidyl(meth)acrylate, etc.; vinyl ester-type monomers such as vinyl acetate, vinyl propionate, etc.; styrenic monomers such as styrene, α-methylstyrene, etc.; hydroxyl group-having monomers such as hydroxyethyl (meth)acrylate, hydroxypropyl(meth)acrylate, hydroxybutyl(meth)acrylate, etc.; olefinic monomers such as ethylene, propylene, isoprene, butadiene, etc.; vinyl ether-type monomers such as vinyl ether, etc.

The copolymerizable monomer also includes polyfunctional monomers such as hexanediol (meth)acrylate, butanediol di(meth)acrylate, (poly)ethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, urethane acrylate, etc.

The acrylic polymer (a) may be prepared by polymerizing the above-mentioned monomer ingredients (C₄₋₁₂ alkyl(meth)acrylate and/or alkoxyalkyl(meth)acrylate, (meth)acrylic acid, optionally other monomer ingredient (copolymerizable monomer)) in any known or conventional polymerization method. The polymerization method for the acrylic polymer (a) includes, for example, a solution polymerization method, an emulsion polymerization method, a bulk polymerization method, a UV irradiation polymerization method, etc. Above all, preferred are a solution polymerization method and an emulsion polymerization method in view of the transparency, the waterproofness and the cost of the polymer; and more preferred is a solution polymerization method.

Not specifically defined, the polymerization initiator for use in polymerization to give the acrylic polymer (a) may be suitably selected from any known and conventional ones. More concretely, the polymerization initiator includes, for example, azo-type polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl 2,2′-azobis(2-methylpropionate), etc.; peroxide-type polymerization initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane, etc. In solution polymerization, an oil-soluble polymerization initiator is preferably used. One or more those polymerization initiators may be used either singly or as combined. The amount of the polymerization initiator to be used may be any ordinary one, and for example, it may be selected from a range of from 0.01 to 1 part by weight or so relative to 100 parts by weight of the entire monomer ingredients constituting the acrylic polymer (a).

Various ordinary solvents may be used in solution polymerization. The solvent may be an organic solvent including, for example, esters such as ethyl acetate, n-butyl acetate, etc.; aromatic hydrocarbons such as toluene, benzene; aliphatic hydrocarbons such as n-hexane, n-heptane, etc.; alicyclic hydrocarbons such as cyclohexane, methylcyclohexane, etc.; ketones such as methyl ethyl ketone, methyl isobutyl ketone, etc. One or more such solvents may be used either singly or as combined.

In emulsion polymerization, any known or conventional emulsifier may be used. The emulsifier includes, for example, anionic emulsifiers such as sodium laurylsulfate, ammonium laurylsulfate, sodium dodecylbenzenesulfonate, sodium polyoxyethylene alkyl ether sulfate, ammonium polyoxyethylene alkylphenyl ether sulfate, sodium polyoxyethylene alkylphenyl ether sulfate, etc.; nonionic emulsifiers such as polyoxyethylene alkyl ether, polyoxyethylene alkylphenyl ether, etc.

The weight-average molecular weight of the acrylic polymer (a) in the invention is preferably from 500,000 to 900,000, more preferably from 600,000 to 900,000. When the weight-average molecular weight of the acrylic polymer (a) is less than 500,000, then the pressure-sensitive adhesive layer could not exhibit the necessary pressure-sensitive adhesive power and cohesive power; but on the other hand, when more than 900,000, then the formability of the pressure-sensitive adhesive layer by coating may worsen owing to the coating failure resulting from the increase in the viscosity of the pressure-sensitive adhesive composition whereby the producibility of the pressure-sensitive adhesive sheet may lower, or the pressure-sensitive adhesive composition may require a large amount of solvent for dilution.

In the invention, the weight-average molecular weight (Mw) of the acrylic polymer (a) and the acrylic oligomer (b) to be mentioned below may be determined according to a gel permeation chromatography (GPC) method. More concretely, as a GPC device, “HLC-8120GPC” (trade name, manufactured by Tosoh Corporation) is used, and the weight-average molecular weight is measured as a polystyrene-equivalent value under the GPC condition mentioned below.

### GPC Condition:

Sample concentration: 0.2% by weight (tetrahydrofuran solution)

Sample amount: 10 μl

Eluent: tetrahydrofuran (THF)

Flow rate (speed): 0.6 mL/min

Column temperature (temperature in measurement): 40° C.

Column: trade name “TSK gel Super HM-H/H4000/H3000/H2000” (manufactured by Tosoh Corporation)

Detector: differential refractometer (RI)

The weight-average molecular weight of the acrylic polymer (a) can be controlled by suitably selecting and changing the type and the amount of the polymerization initiator, the temperature and the time in polymerization, the monomer concentration, the monomer dropping speed, etc.

The glass transition temperature of the acrylic polymer (a) in the invention is preferably −30° C. or lower (for example, from −70 to −30° C.), more preferably −35° C. or lower from the viewpoint of making the pressure-sensitive adhesive sheet of the invention exhibit good pressure-sensitive adhesiveness. The glass transition temperature of the acrylic polymer (a) may be controlled by suitably selecting and changing the type and the contents of the monomer ingredients constituting the acrylic polymer (a).

The glass transition temperature (Tg) of the acrylic polymer (a) is a glass transition temperature (theoretical value) represented by the formula mentioned below. The glass transition temperature of the acrylic oligomer (b) to be mentioned below may be determined in the same manner.

1/Tg=W₁/Tg₁+W₂/Tg₂+ . . . +Wₙ/Tgₙ

In the above formula, Tg means the glass transition temperature of the acrylic copolymer (a) (unit: K), Tgᵢ means the glass transition temperature of the homopolymer of monomer i (unit: K), and Wᵢ means the weight fraction of the monomer i in the entire monomer ingredient (i=1, 2, . . . , n). The above is a computational formula in a case where the acrylic polymer (a) is composed of n types of monomer ingredients of monomer 1, monomer 2 . . . , monomer n. The above-mentioned “glass transition temperature of the homopolymer” corresponds to “glass transition temperature (Tg) of the homopolymer formed of the monomer” to be mentioned below.

### (Acrylic Oligomer (b))

The pressure-sensitive adhesive composition for forming the pressure-sensitive adhesive layer in the invention preferably contains an acrylic oligomer (b) mentioned below, in addition to the above-mentioned acrylic polymer (a). In the case of containing the acrylic oligomer (b), the foaming/peeling resistance of the pressure-sensitive adhesive sheet is enhanced. The acrylic oligomer (b) has a glass transition temperature (Tg) of from 60 to 190° C. when it is formed into the corresponding homopolymer, and this is an oligomer that contains a (meth)acrylate having a cyclic structure in the molecule thereof [this may be referred to as “ring-containing (meth)acrylate of which Tg of the homopolymer is from 60 to 190° C.”] as the main monomer ingredient and further contains acrylic acid and/or methacrylic acid as an indispensable monomer ingredient (that is, containing at least one of acrylic acid and methacrylic acid as an indispensable monomer ingredient). The monomer ingredients constituting the acrylic oligomer (b) may further include, if desired, any other monomer ingredient (copolymerizable monomer) in addition to the above-mentioned, ring-containing (meth)acrylate of which Tg of the homopolymer is from 60 to 190° C., and (meth)acrylic acid. In the invention, “oligomer” means a polymer having a molecular weight of 10,000 or less. The molecular weight may be measured according to the same GPC method as that for Mw mentioned above.

The ring-containing (meth)acrylate of which Tg of the homopolymer is from 60 to 190° C. in the acrylic oligomer (b) has a cyclic structure in the molecule thereof. The cyclic structure (ring) may be any of an aromatic ring or a non-aromatic ring, but is preferably a non-aromatic ring from the viewpoint that the foaming/peeling resistance of the pressure-sensitive adhesive sheet can be bettered more. The aromatic ring includes, for example, aromatic carbon rings (e.g., benzene ring, condensed carbon rings such as naphthalene ring), and various aromatic heterocyclic rings. The non-aromatic ring includes non-aromatic aliphatic rings (non-aromatic alicyclic rings) (cycloalkane rings such as cyclopentane ring, cyclohexane ring, cycloheptane ring, cyclooctane ring, etc.; cycloalkene rings such as cyclohexene ring, etc.); non-aromatic bridged rings (e.g., bicyclic hydrocarbon rings such as pinane, pinene, bornane, norbornane, norbornene, etc.; tricyclic hydrocarbon rings such as in adamantane, etc.; and other bridged hydrocarbon rings including tetracyclic hydrocarbon rings).

The ring-containing (meth)acrylate of which Tg of the homopolymer is from 60 to 190° C. includes (meth)acrylates having a cyclic structure in the molecule thereof, for example, non-aromatic ring-containing (meth)acrylates such as cycloalkyl (meth)acrylates (e.g., cyclohexyl(meth)acrylate), isobornyl(meth)acrylate, etc.; aromatic ring-containing (meth)acrylates such as aryl(meth)acrylates (e.g., phenyl (meth)acrylate), aryloxyalkyl(meth)acrylates (e.g., phenoxyethyl(meth)acrylate), arylalkyl(meth)acrylates (e.g., benzyl(meth)acrylate), etc.; and those capable of forming a homopolymer having a glass transition temperature (Tg) of from 60 to 190° C. may be suitably selected from these monomers for use herein.

When a homopolymer is formed of the ring-containing (meth)acrylate of which Tg of the homopolymer is from 60 to 190° C., its glass transition temperature (Tg) is from 60 to 190° C., preferably from 65 to 180° C. When a (meth)acrylate of which Tg of the homopolymer is lower than 60° C. is used, the pressure-sensitive adhesiveness of the pressure-sensitive adhesive layer may be poor and the pressure-sensitive adhesive layer may be readily foamed and peeled; and on the other hand, when a (meth)acrylate of which Tg of the homopolymer is higher than 190° C. is used, the pressure-sensitive adhesive layer may be hard and may be readily peeled at a low temperature.

“Glass transition temperature (Tg) of the homopolymer formed of the monomer” in the invention (this may be simply referred to as “glass transition temperature (Tg) of the homopolymer”) means “glass transition temperature (Tg) of the homopolymer of the (meth)acrylate”, and its concrete data are shown in “Polymer Handbook” (3rd Ed., by John Wiley & Sons, Inc., 1989). Tg of homopolymers of other (meth)acrylates than those shown in the reference can be measured, for example, according to the measurement method mentioned below (see JP-A 2007-51271, which is herein incorporated by reference). Briefly, 100 parts by weight of a monomer ((meth)acrylate), 0.2 parts by weight of azobisisobutyronitrile and 200 parts by weight of a polymerization solvent, ethyl acetate are put into a reactor equipped with a thermometer, a stirrer, a nitrogen-introducing duct and a reflux condenser tube, and stirred for 1 hour with introducing nitrogen gas thereinto. Oxygen is removed from the polymerization system in that manner, then this is heated up to 63° C. and reacted for 10 hours. Next, this is cooled to room temperature to give a homopolymer solution having a solid concentration of 33% by weight. Next, the homopolymer solution is cast onto a release liner and dried to prepare a test sample having a thickness of about 2 mm (sheet-like homopolymer). The test sample is blanked into a disc having a diameter of 7.9 mm, and sandwiched between parallel plates, and its viscoelasticity is measured using a viscoelasticity tester (ARES, by Rheometrics) with a shear strain of frequency 1 Hz given thereto, in a shear mode within a temperature range of from −70 to 150° C. at a heating speed of 5° C./min, and the peak top temperature at tans is regarded as Tg of the homopolymer.

Specific examples of the ring-containing (meth)acrylate of which Tg of the homopolymer is from 60 to 190° C. includes cyclohexyl methacrylate and isobornyl (meth)acrylate. Of those, especially preferred is cyclohexyl methacrylate from the viewpoint of the transparency of the pressure-sensitive adhesive layer. One or more such ring-containing (meth)acrylates of which Tg of the homopolymer is from 60 to 190° C. may be used herein either singly or as combined.

The content of the ring-containing (meth)acrylate of which Tg of the homopolymer is from 60 to 190° C. (especially cyclohexyl methacrylate) relative to the entire monomer ingredients (total amount of monomer ingredients) constituting the acrylic oligomer (b) is preferably 50% by weight or more, more preferably 80% by weight or more, even more preferably 90% by weight or more, since this monomer is the main monomer ingredient. The uppermost limit of the content of the ring-containing (meth)acrylate of which the homopolymer is from 60 to 190° C. (especially cyclohexyl methacrylate) is preferably 99% by weight or less, more preferably 97% by weight or less, since the monomer ingredients contain at least (meth)acrylic acid as an indispensable monomer ingredient. In case where the content of the ring-containing (meth)acrylate of which Tg of the homopolymer is from 60 to 190° C. is less than 50% by weight relative to the entire monomer ingredients, then the pressure-sensitive adhesive layer may be readily foamed and peeled.

The monomer ingredients constituting the acrylic oligomer (b) contain (meth)acrylic acid. The total content of acrylic acid and methacrylic acid relative to the entire monomer ingredients (total amount of monomer ingredients) (100% by weight) constituting the acrylic oligomer (b) is 10% by weight or less (e.g., from 0.1 to 10% by weight), preferably from 2.5 to 10% by weight, more preferably from 3 to 10% by weight. When the total content of acrylic acid and methacrylic acid is more than 10% by weight, then the extracted (meth)acrylic acid ion amount could not be controlled to be 20 ng/cm² or less. On the other hand, when the total content of acrylic acid and methacrylic acid is small or 0% by weight, then the transparency of the pressure-sensitive adhesive layer may lower. In particular, in case where the acrylic oligomer (b) is a polymer containing acrylic acid as an indispensable monomer ingredient, the acrylic acid content preferably satisfies the above range.

In the acrylic oligomer (b), if desired, any other monomer ingredient (copolymerizable monomer) capable of copolymerizing with the ring-containing (meth)acrylate of which Tg of the homopolymer is from 60 to 190° C. and (meth)acrylic acid may be used as a monomer ingredient constituting the acrylic oligomer (b) in combination thereto. Not specifically defined, the copolymerizable monomer content relative to the entire monomer ingredients (total amount of monomer ingredients) (100% by weight) constituting the acrylic oligomer (b) may be suitably selected depending on the type of the copolymerizable monomer, but is preferably 49.9% by weight or less (from 0 to 49.9% by weight), more preferably 30% by weight or less.

The copolymerizable monomer for the acrylic oligomer (b) includes, for example, alkyl(meth)acrylates such as methyl(meth)acrylate, ethyl(meth)acrylate, propyl(meth)acrylate, isopropyl(meth)acrylate, n-butyl(meth)acrylate, isobutyl (meth)acrylate, s-butyl(meth)acrylate, t-butyl(meth)acrylate, pentyl(meth)acrylate, hexyl(meth)acrylate, heptyl(meth)acrylate, octyl(meth)acrylate, 2-ethylhexyl (meth)acrylate, isooctyl(meth)acrylate, nonyl(meth)acrylate, isononyl(meth)acrylate, decyl(meth)acrylate, isodecyl(meth)acrylate, etc.; carboxyl group-having monomers except acrylic acid and methacrylic acid, such as itaconic acid, maleic acid, fumaric acid, crotonic acid, etc., and acid anhydrides of these carboxyl group-having monomers (e.g., acid anhydride group-having monomers such as maleic anhydride, itaconic anhydride); epoxy group-having acrylic monomers such as glycidyl(meth)acrylate, methylglycidyl(meth)acrylate, etc.; vinyl ester-type monomers such as vinyl acetate, vinyl propionate, etc.; hydroxyl group-having monomers such as hydroxyethyl (meth)acrylate, hydroxypropyl(meth)acrylate, hydroxybutyl(meth)acrylate, etc.; alkoxyalkyl(meth)acrylate monomers such as methoxyethyl(meth)acrylate, ethoxyethyl(meth)acrylate, etc.; olefinic monomers such as ethylene, propylene, isoprene, butadiene, etc.; vinyl ether-type monomers such as vinyl ether, etc. The copolymerizable monomer is preferably so selected that Tg of the acrylic oligomer (b) could be 60° C. or higher.

The copolymerizable monomer also includes polyfunctional monomers such as hexanediol di(meth)acrylate, butanediol di(meth)acrylate, (poly)ethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, urethane acrylate, etc.

As the copolymerizable monomer, nitrogen atom-having monomers [for example, aminoalkyl(meth)acrylate monomers such as aminoethyl(meth)acrylate, N,N-dimethylaminoethyl(meth)acrylate, t-butylaminoethyl(meth)acrylate, etc.; (N-substituted amide monomers such as (meth)acrylamide, N,N-dimethyl(meth)acrylamide, N-butyl(meth)acrylamide, N-hydroxy(meth)acrylamide, etc.; cyano group-having monomers such as acrylonitrile, methacrylonitrile, etc.; isocyanate group-having monomers such as 2-methacryloyloxyethyl isocyanate, etc.] are undesirable since they cause yellowing of the pressure-sensitive adhesive layer under heat. Specifically, it is desirable that the entire monomer ingredients constituting the acrylic oligomer (b) does not substantially contain a nitrogen atom-having monomer. Concretely, the content of a nitrogen atom-having monomer relative to the entire monomer ingredients (total amount of monomer ingredients) constituting the acrylic oligomer (b) is preferably less than 3% by weight, more preferably less than 1% by weight.

The acrylic oligomer (b) may be prepared by polymerizing the above-mentioned monomer ingredients (ring-containing (meth)acrylate of which Tg of the homopolymer is from 60 to 190° C., (meth)acrylic acid, optionally other monomer ingredient (comonomer)) in any known or conventional polymerization method. The polymerization method for the acrylic oligomer (b) includes, for example, a solution polymerization method, an emulsion polymerization method, a bulk polymerization method, a UV irradiation polymerization method, etc. Above all, preferred are a solution polymerization method and an emulsion polymerization method in view of the transparency, the waterproofness and the cost of the oligomer; and more preferred is a solution polymerization method.

Not specifically defined, the polymerization initiator, the chain transfer agent and others for use in polymerization to give the acrylic oligomer (b) may be suitably selected from any known and conventional ones. More concretely, the polymerization initiator includes, for example, azo-type polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl 2,2′-azobis(2-methylpropionate), etc.; peroxide-type polymerization initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane, etc. In solution polymerization, an oil-soluble polymerization initiator is preferably used. One or more those polymerization initiators may be used either singly or as combined. The amount of the polymerization initiator to be used may be any ordinary one, and for example, it may be selected from a range of from 0.1 to 15 parts by weight or so relative to 100 parts by weight of the entire monomer ingredients constituting the acrylic oligomer (b).

The chain transfer agent includes, for example, 2-mercaptoethanol, laurylmercaptan, glycidylmercaptan, mercaptoacetic acid, thioglycolic acid, 2-ethylhexyl thioglycolate, 2,3-dimercapto-1-propanol, α-methylstyrene dimer, etc. The amount of the chain transfer agent to be used may be any ordinary one, and is, for example, selected from a range of from 0.01 to 15 parts by weight or so relative to 100 parts by weight of the entire monomer ingredients constituting the acrylic oligomer (b).

Various ordinary solvents may be used in solution polymerization. The solvent may be an organic solvent including, for example, esters such as ethyl acetate, n-butyl acetate, etc.; aromatic hydrocarbons such as toluene, benzene; aliphatic hydrocarbons such as n-hexane, n-heptane, etc.; alicyclic hydrocarbons such as cyclohexane, methylcyclohexane, etc.; ketones such as methyl ethyl ketone, methyl isobutyl ketone, etc. One or more such solvents may be used either singly or as combined.

In emulsion polymerization, any known or conventional emulsifier may be used. The emulsifier includes, for example, anionic emulsifiers such as sodium laurylsulfate, ammonium laurylsulfate, sodium dodecylbenzenesulfonate, sodium polyoxyethylene alkyl ether sulfate, ammonium polyoxyethylene alkylphenyl ether sulfate, sodium polyoxyethylene alkylphenyl ether sulfate, etc.; nonionic emulsifiers such as polyoxyethylene alkyl ether, polyoxyethylene alkylphenyl ether, etc.

The weight-average molecular weight of the acrylic oligomer (b) in the invention is preferably 3000 or more but less than 6000, more preferably from 3300 to 5500, even more preferably from 3500 to 5000. When the weight-average molecular weight of the acrylic oligomer (b) is less than 3000, then the pressure-sensitive adhesive layer may be readily foamed and peeled; but when 6000 or more, then the transparency thereof may lower.

The weight-average molecular weight of the acrylic oligomer (b) can be controlled by suitably selecting and changing the type and the amount of the polymerization initiator and the chain transfer agent, the temperature and the time in polymerization, the monomer concentration, the monomer dropping speed, etc.

The glass transition temperature (Tg) of the acrylic oligomer (b) in the invention is preferably from 60 to 190° C., more preferably from 60 to 180° C. from the viewpoint of making the pressure-sensitive adhesive sheet of the invention exhibit good pressure-sensitive adhesiveness and enhancing the foaming/peeling resistance of the pressure-sensitive adhesive layer. The glass transition temperature of the acrylic oligomer (b) may be controlled by suitably selecting and changing the type and the contents of the monomer ingredients constituting the acrylic oligomer (b).

### (Pressure-Sensitive Adhesive Composition)

The pressure-sensitive adhesive composition for forming the pressure-sensitive adhesive layer in the invention contains the above-mentioned acrylic polymer (a) as an indispensable ingredient thereof. Further, from the viewpoint of enhancing the foaming/peeling resistance of the layer, preferably, the composition further contains the acrylic oligomer (b). Preferably, the pressure-sensitive adhesive composition contains the acrylic oligomer (b) in an amount of from 10 to 35 parts by weight, more preferably from 15 to 30 parts by weight relative to 100 parts by weight of the acrylic polymer (a) therein. When the content of the acrylic oligomer (b) relative to 100 parts by weight of the acrylic polymer (a) is less than 10 parts by weight, then the acrylic oligomer (b) could hardly exhibit its effect and the foaming/peeling resistance of the layer may worsen; but when more than 35 parts by weight, the transparency of the layer may lower.

In case where the pressure-sensitive adhesive composition for forming the pressure-sensitive adhesive layer in the invention contains the acrylic polymer (a) and the acrylic oligomer (b) in the specific blend ratio as above, then the pressure-sensitive adhesive layer formed of the pressure-sensitive adhesive composition may be excellent both in the cohesion power (drag to shear force) and the pressure-sensitive adhesiveness (interfacial drag in the vertical direction). Accordingly, for example, when the pressure-sensitive adhesive sheet is stuck to a plastic substrate, the pressure-sensitive adhesive layer is excellent in foaming/peeling resistance in that it does neither swell nor peel in the adhesion interface owing to the bubbles (foaming) from the substrate. In addition, the pressure-sensitive adhesive layer is excellent in transparency.

Not specifically defined, the content of the acrylic polymer (a) in the pressure-sensitive adhesive composition is, for example, preferably from 65 to 95% by weight, more preferably from 70 to 90% by weight relative to 100% by weight of the solid content of the pressure-sensitive adhesive composition, from the viewpoint of satisfying both the transparency and the foaming/peeling resistance.

The pressure-sensitive adhesive composition may optionally contain known additives such as crosslinking agent, UV absorbent, antioxidant, light stabilizer, antiaging agent, tackifier, plasticizer, softening agent, filler, colorant (e.g., pigment, dye), surfactant, antistatic agent, etc., and solvents (e.g., water-base solvents and organic solvents such as those mentioned in the above), in addition to the acrylic polymer (a) and the acrylic oligomer (b).

In the invention, in forming the pressure-sensitive adhesive layer, a crosslinking agent may be used to crosslink the acrylic polymer (a) and the acrylic oligomer (b) to thereby further increase the cohesion force of the pressure-sensitive adhesive layer. Accordingly, the pressure-sensitive adhesive composition for forming the pressure-sensitive adhesive layer in the invention preferably contains a crosslinking agent along with the acrylic polymer (a) and the acrylic oligomer (b). For the crosslinking, preferred is a thermal crosslinking method.

Not specifically defined, the crosslinking agent may be any known one. As the crosslinking agent, preferred are polyfunctional melamine compounds (melamine-type crosslinking agents), polyfunctional epoxy compounds (epoxy-type crosslinking agents), polyfunctional isocyanate compounds (isocyanate-type crosslinking agents). One or more such crosslinking agents may be used herein either singly or as combined.

The polyfunctional melamine compounds include, for example, methylated trimethylolmelamine, butylated hexamethylolmelamine, etc. The polyfunctional epoxy compounds include, for example, diglycidylaniline, glycerin diglycidyl ether, etc. The polyfunctional isocyanate compounds include tolylene diisocyanate, hexamethylene diisocyanate, polymethylene polyphenyl isocyanate, diphenylmethane diisocyanate, diphenylmethane diisocyanate dimer, reaction product of trimethylolpropane and tolylene diisocyanate, reaction product of trimethylolpropane and hexamethylene diisocyanate, polyether polyisocyanate, polyester polyisocyanate, etc.

Not specifically defined, the amount of the crosslinking agent to be used (the amount thereof to be added) is, for example, preferably from 0.001 to 20 parts by weight, more preferably from 0.001 to 10 parts by weight, relative to 100 parts by weight of the acrylic polymer (a). When the amount of the crosslinking agent to be used is less than 0.001 parts by weight, then the pressure-sensitive adhesive layer may readily foam, but when more than 20 parts by weight, the layer may readily peel.

Not specifically defined, the pressure-sensitive adhesive composition may be prepared by mixing the acrylic polymer (a), the acrylic oligomer (b) and optionally other additives such as crosslinking agent, solvent, etc.

### (Pressure-Sensitive Adhesive Layer)

The pressure-sensitive adhesive layer in the invention is formed of the pressure-sensitive adhesive composition mentioned in the above. The pressure-sensitive adhesive layer in the invention may be either a single layer or a laminate layer.

Not specifically defined, the thickness of the pressure-sensitive adhesive layer is preferably from 3 to 60 μm, more preferably from 3 to 40 μm, even more preferably from 5 to 35 μm. When the thickness of the pressure-sensitive adhesive layer is less than 3 μm, then the layer may readily peel; but when more than 60 μm, then the extracted (meth)acrylic acid ion amount could not be controlled to be 20 ng/cm² or less.

The gel fraction of the pressure-sensitive adhesive layer in the invention is preferably from 30 to 80% (% by weight), more preferably from 35 to 80% from the viewpoint of exhibiting good foaming/peeling resistance. The gel fraction can be determined as the ethyl acetate-insoluble fraction. Concretely, the pressure-sensitive adhesive sheet is dipped in ethyl acetate at 23° C. for 7 days, and the insoluble fraction is determined by weight (unit, % by weight) relative to the sample before dipping. The gel fraction can be controlled by controlling the monomer composition and the weight-average molecular weight of the acrylic polymer (a) and the acrylic oligomer (b), the blend ratio of the acrylic polymer (a) and the acrylic oligomer (b) in the pressure-sensitive adhesive composition, the amount of the crosslinking agent, etc. When the gel fraction is less than 30%, then the pressure-sensitive adhesive layer may readily foam; but when more than 80%, the layer may readily peel.

In the present invention, concretely, the gel fraction (proportion of the solvent-insoluble fraction) is a value to be computed according to the “method for determination of gel fraction” mentioned below.

### (Method for Determination of Gel Fraction)

About 0.1 g of the pressure-sensitive adhesive layer is sampled from the pressure-sensitive adhesive sheet of the invention, this is wrapped with a porous tetrafluoroethylene sheet having a mean pore size of 0.2 μm (trade name “NTF1122” manufactured by Nitto Denko Corporation), tied up with a kite string, its weight is measured, and this is the weight before dipping. The weight before dipping is a sum total of the pressure-sensitive adhesive layer (pressure-sensitive adhesive layer of the invention sampled in the above), the tetrafluoroethylene sheet, and the kite string. The total weight of the tetrafluoroethylene sheet and the kite string is also measured, and this is the weight of the wrap.

Next, the pressure-sensitive adhesive layer wrapped with tetrafluoroethylene sheet and tied up with kite string (hereinafter this is referred to as “sample”) is put into a 50-ml container filled with ethyl acetate, and kept at 23° C. for 7 days. Next, the sample (treated with ethyl acetate) is taken out of the container, transferred into an aluminium cap, and dried in a drier at 130° C. for 2 days to remove ethyl acetate, and its weight is measured. This is the weight after dipping.

The gel fraction is computed according to the following formula:

Gel Fraction(% by weight)=(A−B)/(C−B)×100 (1)

In formula (I), A is the weight after dipping, B is the weight of the wrap, C is the weight before dipping.

Preferably, the pressure-sensitive adhesive layer of the invention has high transparency; and for example, the whole light transmittance in a visible light range (according to JIS K 7361) of the layer is preferably at least 90%, more preferably at least 91%. The haze value of the pressure-sensitive adhesive layer of the invention (according to JIS K 7136) is, for example, preferably less than 1.0%, more preferably less than 0.8%. The whole light transmittance and the haze value may be measured by sticking the pressure-sensitive adhesive layer of the invention to a slide glass (for example, having a whole light transmittance of 91.8% and a haze value of 0.4%) and analyzing it with a haze meter (Murakami Color Search Laboratory's trade name “HM-150”).

The method for forming the pressure-sensitive adhesive layer in the invention is not specifically defined. For example, the above-mentioned pressure-sensitive adhesive composition is applied onto a substrate or a release liner by coating with it, and optionally it is dried and/or cured to form the pressure-sensitive adhesive layer of the invention. In particular, in case where a substrate-less double-sided pressure-sensitive adhesive sheet composed only of the pressure-sensitive adhesive layer of the invention is produced, the pressure-sensitive adhesive composition is applied onto a release liner by coating with it, and optionally it is dried and/or cured to form the pressure-sensitive adhesive layer of the invention.

For coating with the pressure-sensitive adhesive composition, any known coating method may be employed, in which, for example, usable is any known coater such as gravure roll coater, reverse roll coater, kiss roll coater, dip roll coater, bar coater, knife coater, spray coater, etc.

The process of forming the pressure-sensitive adhesive layer in the invention preferably includes a step of heat treatment at a relatively high temperature, concretely a step of drying at a relatively high temperature (high-temperature drying step). Namely, it is desirable that the pressure-sensitive adhesive composition is applied onto a substrate or a release liner by coating with it, and then dried at a high temperature (and optionally cured) to form the pressure-sensitive adhesive layer of the invention. The heating temperature (drying temperature) in the heat treatment step (especially high-temperature drying step) is preferably from 135 to 160° C., more preferably from 145 to 160° C. The heating time (drying time) in the heat treatment step (especially high-temperature drying step) is preferably from 40 to 300 seconds, more preferably from 60 to 200 seconds. In the heat treatment step (especially high-temperature drying step), (meth)acrylic acid can be removed, and therefore, the extracted (meth)acrylic acid ion amount (that is, the (meth)acrylic acid ion amount to dissolve in water) may be reduced, and the corrosion resistance of the pressure-sensitive adhesive sheet is thereby favorably enhanced. When the heating temperature (drying temperature) is lower than 135° C. or when the heating time (drying time) is shorter than 40 seconds, then the extracted (meth)acrylic acid ion amount could not be sufficiently reduced, and the corrosion resistance of the pressure-sensitive adhesive sheet may worsen. On the other hand, when the heating temperature (drying temperature) is higher than 160° C. or when the heating time (drying time) is longer than 300 seconds, then, for example, the release liner may have some trouble.

The process of forming the pressure-sensitive adhesive layer in the invention may further include, in addition to the step of heat treatment at a relatively high temperature, a predrying step at a low temperature from the viewpoint of preventing the pressure-sensitive adhesive layer from foaming owing to rapid drying to detract from the surface smoothness of the layer and of preventing the surface of the pressure-sensitive adhesive layer from foaming. Not specifically defined, the predrying may be attained, for example, under the condition of a drying temperature of from 30 to 80° C. (more preferably from 30 to 60° C.) for a drying time of at least 20 seconds (for example, from 20 to 200 seconds, more preferably at least 30 seconds).

Accordingly, a concrete method of forming the pressure-sensitive adhesive layer in the invention comprises, for example, applying the pressure-sensitive adhesive composition onto a substrate or a release liner by coating with it, then pre-drying it under the condition of a drying temperature of from 30 to 80° C. (more preferably from 30 to 60° C.) for a drying time of at least 20 seconds (more preferably at least 30 seconds), and then drying it under the condition of a high temperature of from 135 to 160° C. (more preferably from 145 to 160° C.) for a drying time of from 40 to 300 seconds (more preferably from 60 to 200 seconds) (and optionally curing it) thereby forming the pressure-sensitive adhesive layer. The drying may be attained under normal pressure or under reduced pressure (for example, under a pressure of from 200 to 700 hPa).

### Pressure-Sensitive Adhesive Sheet

The pressure-sensitive adhesive sheet of the invention has at least one pressure-sensitive adhesive layer of the invention mentioned above (formed of a pressure-sensitive adhesive composition containing the acrylic polymer (a) as an indispensable ingredient thereof). The concrete constitution of the pressure-sensitive adhesive sheet of the invention includes, for example, (1) a substrate-less double-sided pressure-sensitive adhesive sheet composed only of the pressure-sensitive adhesive layer of the invention (substrate-less double-sided pressure-sensitive adhesive sheet), (2) a substrate-less double-sided pressure-sensitive adhesive sheet including the pressure-sensitive adhesive layer of the invention and any other pressure-sensitive adhesive layer, (3) a substrate-having double-sided pressure-sensitive adhesive sheet having the pressure-sensitive adhesive layer of the invention on both surfaces of the substrate, (4) a substrate-having double-sided pressure-sensitive adhesive sheet having the pressure-sensitive adhesive layer of the invention on one surface of the substrate and having a different pressure-sensitive adhesive layer on the other surface thereof, (5) a substrate-having single-sided pressure-sensitive adhesive sheet having the pressure-sensitive adhesive layer of the invention on one surface of the substrate. Above all, the substrate-less double-sided pressure-sensitive adhesive sheet (1) composed only of the pressure-sensitive adhesive layer of the invention is preferred.

### (Substrate)

In case where the pressure-sensitive adhesive sheet of the invention has a substrate, the substrate is not specifically defined. For example, the substrate includes plastic films, and various optical films such as antireflection (AR) films, polarization films, retardation films, etc. The materials of the plastic films are various plastic materials including, for example, polyester resins such as polyethylene terephthalate (PET), etc.; acrylic resins such as polymethyl methacrylate (PMMA), etc.; polycarbonates, triacetyl cellulose, polysulfones, polyarylates; cyclic olefin polymers such as “ARTON” (cyclic olefin polymer, manufactured by JSR Corporation), “ZEONOA” (cyclic olefin polymer, manufactured by Zeon Corporation), etc. One or more such plastic materials may be used either singly or as combined. The “substrate” is the part of the pressure-sensitive adhesive sheet to be stuck to an object (e.g., metal thin film) along with the pressure-sensitive adhesive layer thereof when the pressure-sensitive adhesive sheet is applied (stuck) to the object. The release liner (separator) to be released in use (for sticking) of the pressure-sensitive adhesive sheet is not the “substrate”.

Of those mentioned in the above, the substrate is preferably a transparent substrate. The “transparent substrate” preferably has a whole light transmittance in a visible light region (according to JIS K 7361) of at least 85%, more preferably at least 90%. The transparent substrate includes, for example, a PET film or a non-oriented film such as “ARTON” (trade name) and “ZEONOA” (trade name).

As the substrate, especially preferred is a PET film having a whole light transmittance (according to JIS K 7361) of at least 90% and a haze value (according to JIS K7136) of at most 2.0%.

Not specifically defined, the thickness of the substrate is, for example, preferably from 25 to 75 μm. The substrate may be in any form of a single layer or a multilayer. The surface of the substrate may be suitably subjected to any known or conventional surface treatment, for example, physical treatment such as corona discharge treatment or plasma treatment or chemical treatment such as undercoating treatment, etc.

In case where the pressure-sensitive adhesive sheet of the invention has a substrate, various functional films may be used for the substrate. In this case, the pressure-sensitive adhesive sheet of the invention may be a pressure-sensitive adhesive functional sheet having the pressure-sensitive adhesive layer of the invention on at least one surface of the functional film. Not specifically defined, the functional film includes, for example, films with optical functionality (e.g., polarizability, light refractivity, light scatterability, light reflectivity, light transmittance, light absorbability, light diffraction capability, optical rotation capability, visibility), electroconductive films (e.g., ITO film), UV-cut films, hard coat films (with scratch resistance), etc. More concretely, there are mentioned hard coat films (plastic films such as PET films of which at least one surface is subjected to hard coat treatment), polarization films, wave plates, retardation films, optical compensation films, brightening films, light guide plates, reflection films, antireflection films, transparent electroconductive films (e.g., ITO film), design films, decoration films, surface-protected films, prisms, color filters, etc. The pressure-sensitive adhesive functional films include, for example, pressure-sensitive adhesive hard coat films having the pressure-sensitive adhesive layer of the invention on the non-hard-coat surface of a hard coat film of a PET film of which one surface is processed for hard coat treatment. “Plate” and “film” as referred to herein shall include plate-like, film-like and sheet-like forms; and for example, “polarization film” shall include “polarization plate” and “polarization sheet”. “Functional film” shall include “functional plate” and “functional sheet”.

### (Other Pressure-Sensitive Adhesive Layer)

In case where the pressure-sensitive adhesive sheet of the invention has any other pressure-sensitive adhesive layer, the other pressure-sensitive adhesive layer is not specifically defined, for which, for example, there may be mentioned any known or conventional pressure-sensitive adhesive layer formed of a known pressure-sensitive adhesive such as an urethane pressure-sensitive adhesive, an acrylic pressure-sensitive adhesive, a rubber pressure-sensitive adhesive, a silicone pressure-sensitive adhesive, a polyester pressure-sensitive adhesive, a polyamide pressure-sensitive adhesive, an epoxy pressure-sensitive adhesive, a vinyl alkyl ether pressure-sensitive adhesive, a fluorine-containing pressure-sensitive adhesive, etc. One or more such pressure-sensitive adhesives may be used either singly or as combined. The other pressure-sensitive adhesive layer may be any other acrylic pressure-sensitive adhesive layer than the pressure-sensitive adhesive layer of the invention.

### (Release Liner)

The pressure-sensitive adhesive layer surface (pressure-sensitive adhesive surface) of the pressure-sensitive adhesive sheet of the invention may be protected with a release liner (separator) until use. The release liner serves as a protective material for the pressure-sensitive adhesive layer, and when the pressure-sensitive adhesive sheet is stuck to an object, the release liner is peeled away. In case where the pressure-sensitive adhesive sheet is a substrate-less pressure-sensitive adhesive sheet, the release liner serves also as a support for the pressure-sensitive adhesive layer. The release liner is not indispensable. As the release liner, usable is any ordinary release paper or the like. Not specifically defined, also usable are substrates having a lubrication-processed layer, a poorly-adhesive substrate comprising a fluorine-containing polymer, a poorly-adhesive substrate comprising a non-polar polymer, etc. The substrate having a lubrication-processed layer includes, for example, plastic films and paper surface-treated with a lubrication-processing agent such as silicone compounds, long-chain alkyl compounds, fluorine compounds, molybdenum sulfide, etc. The fluorine-containing polymer for the poorly-adhesive substrate comprising a fluorine-containing polymer includes, for example, polytetrafluoroethylene, polychlorotrifluoroethylene, polyvinyl fluoride, polyvinylidene fluoride, tetrafluoroethylene/hexafluoroethylene copolymer, chlorofluoroethylene/vinylidene fluoride copolymer, etc. The non-polar polymer for the poorly-adhesive substrate comprising a non-polar polymer includes, for example, olefinic resins (e.g., polyethylene, polypropylene), etc. The release liner may be formed in any known or conventional method. The thickness of the release liner is not specifically defined.

The total amount of the acrylic acid and methacrylic acid ions extracted from the pressure-sensitive adhesive sheet of the invention with pure water at 100° C. for 45 minutes [extracted (meth)acrylic acid ion amount], measured in accordance with an ion chromatography, is 20 ng/cm² or less (for example, from 0 to 20 ng/cm²) pre the unit area of the pressure-sensitive adhesive layer in the invention, preferably 10 ng/cm² or less (for example, from 0 to 10 ng/cm²), more preferably 5 ng/cm² or less (for example, from 0 to 5 ng/cm²). The extracted (meth)acrylic acid ion amount indicates the degree of acrylic acid ion and methacrylic acid ion releasability with water from the pressure-sensitive adhesive layer when the pressure-sensitive adhesive sheet is put in a wet environment. In case where the extracted (meth)acrylic acid ion amount is more than 20 ng/cm², and when the pressure-sensitive adhesive sheet is stuck to a metal thin film and stored in the presence of water in a wet condition, the metal thin film may be corroded due to the influence of the (meth)acrylic acid ions released from the pressure-sensitive adhesive layer thereon and the resistance (electroconductivity) of the metal thin film may readily change.

Of the above, in case where the acrylic polymer (a) and the acrylic oligomer (b) respectively contain acrylic acid as an indispensable constitutive monomer ingredient, then the acrylic acid ion amount preferably satisfies the above range.

The “total amount of the acrylic acid and methacrylic acid ions extracted from the pressure-sensitive adhesive sheet of the invention with pure water at 100° C. for 45 minutes, measured in accordance with an ion chromatography” can be measured according to the method mentioned below.

First, the pressure-sensitive adhesive sheet is cut into a piece having a suitable size. When the sheet has a release liner, the release liner is peeled from the piece and the pressure-sensitive adhesive surface is exposed out, whereby a test piece is thus prepared. When the pressure-sensitive adhesive sheet is a double-sided pressure-sensitive adhesive sheet, a PET film (having a thickness of from 25 to 50 μm) is stuck to one pressure-sensitive adhesive surface, and only the other pressure-sensitive adhesive surface is made exposed out. In this stage, the pressure-sensitive adhesive face on the side that is stuck to a metal thin film (the surface of the pressure-sensitive adhesive layer of the invention in the pressure-sensitive adhesive sheet of the invention) is exposed out. The size of the test piece (the exposed area of the pressure-sensitive adhesive face) is preferably 100 cm².

Next, the test piece is put in a pure water at a temperature of 100° C., and boiled therein for 45 minutes for boiling extraction of acrylic acid ion and methacrylic acid ion.

Next, the total amount (unit, ng) of the acrylic acid ion and the methacrylic acid ion in the extract is measured in accordance with an ion chromatography, and the total amount (unit, ng/cm²) of the acrylic acid ion and the methacrylic acid ion per the unit area of the pressure-sensitive adhesive surface (exposed pressure-sensitive adhesive face) of the test piece is computed. According to the present invention, the conditions of the ion chromatography are as follows:

### (Conditions of Ion Chromatography)

| | |
|---|---|
| Analysis Device: | DIONEX's DX-320 |
| Separation Column: | Ion Pac AS15 (4 mm × 250 mm) |
| Guard Column: | Ion Pac AG15 (4 mm × 50 mm) |
| Removal System: | ASRS-ULTRA (external mode, 100 mA) |
| Detector: | Electroconductivity detector |
| Eluent: | 7 mM KOH (0 to 20 minutes) |
| | 45 mM KOH (20 to 30 minutes) |
| | (An eluent generator EG40 is used.) |
| Eluent Flow Rate: | 1.0 ml/min |
| Injected Sample | 250 μl |
| Amount: | |

The (meth)acrylic acid ion released with water from the pressure-sensitive adhesive sheet generally results from the (meth)acrylic acid that remains unreacted in the pressure-sensitive adhesive layer. The (meth)acrylic acid ion is presumed to penetrate into a metal thin film in the presence of water in a high-temperature high-humidity condition, thereby detracting from electroconductivity of the metal thin film, and it induces the resistance increase in the metal thin film (corrosion of the metal thin film). For enhancing the adhesiveness of the pressure-sensitive adhesive sheet, in general, a relatively large amount of (meth)acrylic acid (especially acrylic acid) is used as the monomer ingredient for the polymer and the oligomer constituting the pressure-sensitive adhesive layer; but in this case, unreacted (meth)acrylic acid readily remains in the pressure-sensitive adhesive layer and the amount of the (meth)acrylic acid ion to be released with water from the pressure-sensitive adhesive sheet is thereby increased. As opposed to this, in the invention, the amount of (meth)acrylic acid remaining in the pressure-sensitive adhesive layer is reduced by drying, and therefore the amount of the (meth)acrylic acid ion to be released with water from the pressure-sensitive adhesive sheet is small, and the corrosion of the thin metal film as an adherend and the resistance change in the thin metal film caused by the (meth)acrylic acid ion can be retarded. Accordingly, even when (meth)acrylic acid is used as a monomer ingredient of the polymer and the oligomer constituting the pressure-sensitive adhesive layer, the pressure-sensitive adhesive sheet of the invention can still exhibit excellent corrosion resistance.

The pressure-sensitive adhesive sheet of the invention is excellent in the corrosion resistance, and is therefore favorably used for sticking to a metal thin film (metal thin film or metal oxide thin film). Not specifically defined, the metal thin film is, for example, a thin film of a metal, a metal oxide or mixture of them. For example, the metal thin film is a thin film of ITO (indium tin oxide), ZnO, SnO or CTO (cadmium tin oxide). Also not specifically defined, the thickness of the metal thin film is preferably from 100 to 2000 angstroms. The metal thin film of ITO or the like is provided, for example, on a PET film and is used as a transparent electroconductive film. The pressure-sensitive adhesive layer of the invention has excellent corrosion resistance, and therefore, when the pressure-sensitive adhesive sheet of the invention is stuck to a metal thin film, the surface of the pressure-sensitive adhesive layer of the pressure-sensitive adhesive sheet preferably faces the metal thin film.

The pressure-sensitive adhesive layer in the pressure-sensitive adhesive sheet of the invention has excellent adhesiveness, and in particular, when the pressure-sensitive adhesive layer is formed of an adhesive composition containing the acrylic polymer (a) and the acrylic oligomer (b) as indispensable ingredients, it has excellent foaming/peeling resistance. Accordingly, even when the pressure-sensitive adhesive sheet is stuck to an adherend and then the adherend releases bubbles under a severe condition such as a high temperature, the adhering interface between the pressure-sensitive adhesive sheet and the adherend is prevented from being foamed or swollen or peeled due to the bubbles formed by the adherend. Therefore, in case where the pressure-sensitive adhesive sheet of the invention is used for sticking an optical film to construct an optical product, the product can keep its excellent visibility and is free from a trouble of appearance failure, and the pressure-sensitive adhesive sheet of the invention is favorable for the use.

In the pressure-sensitive adhesive sheet of the invention, the acrylic polymer (a) constituting the pressure-sensitive adhesive layer contains (meth)acrylic acid as a monomer ingredient, and in particular, the acrylic oligomer (b), if any, in the pressure-sensitive adhesive layer also contains (meth)acrylic acid as a monomer ingredient, and the molecular weight and the composition of the acrylic oligomer (b) are specifically defined. Accordingly, the pressure-sensitive adhesive layer is not cloudy and has excellent transparency. As so mentioned above, in addition, the pressure-sensitive adhesive layer is excellent in foaming/peeling resistance. For these reasons, the pressure-sensitive adhesive sheet of the invention is favorably used in production of optical products. The optical products include, for example, display devices such as liquid-crystal display devices, organic EL (electroluminescent) display devices, PDP (plasma display panels), as well as touch panels, etc.

For example, the pressure-sensitive adhesive sheet of the invention can be used in production of touch panels as a pressure-sensitive adhesive sheet for touch panels. For example, in production of capacitance-type touch panels, the pressure-sensitive adhesive sheet of the invention may be used for sticking a polymethyl methacrylate (PMMA) film or a hard coat film to a transparent electroconductive film coated with a metal thin film of ITO or the like, via the pressure-sensitive adhesive sheet of the invention. Not specifically defined, the touch panels may be used in portable telephones, etc.

In case where the pressure-sensitive adhesive sheet of the invention is a double-sided adhesive sheet, it may be stuck to and laminated on at least one surface of various functional films, thereby producing an adhesive functional film having the pressure-sensitive adhesive layer of the invention on at least one surface of the functional film. The functional film is described hereinabove. For example, the pressure-sensitive adhesive sheet of the invention may be stuck to and laminated on the non-hard coat-processed surface of a hard coat film prepared by hard-coat treatment of one surface of a PET film (hard coat PET film), thereby producing a pressure-sensitive adhesive hard coat film having a pressure-sensitive adhesive layer (pressure-sensitive adhesive layer of the invention). The double-sided pressure-sensitive adhesive sheet of the invention to be used for the pressure-sensitive adhesive functional film may be a substrate-less double-sided pressure-sensitive adhesive sheet or a substrate-having double-sided pressure-sensitive adhesive sheet.

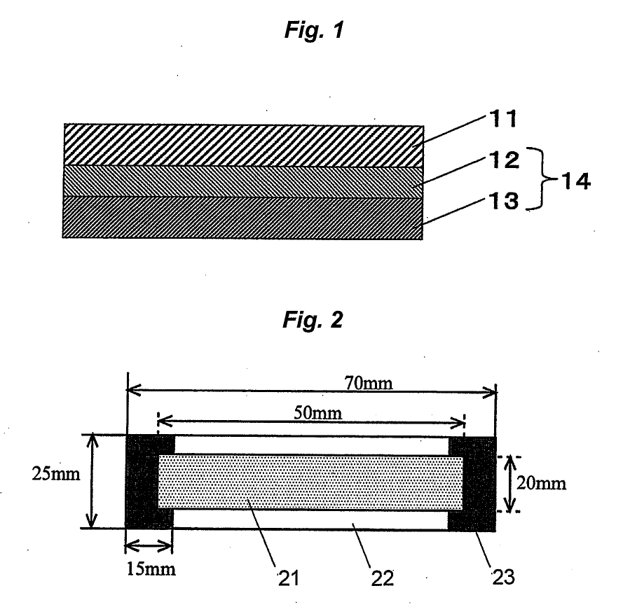

The pressure-sensitive adhesive face (the surface of the pressure-sensitive adhesive layer of the invention) of the pressure-sensitive adhesive functional film may be stuck to the electrode face (ITO face) of an ITO film (ITO layer-coated film) thereby producing a laminate of a functional film and an ITO film. FIG. 1 shows one example of a laminate of a functional film (hard coat PET film) and an ITO film, in which a hard coat film is used as the functional film. In FIG. 1, a pressure-sensitive adhesive sheet 12 (substrate-less double-sided pressure-sensitive adhesive sheet) of the invention is laminated on the non-hard coat-processed surface of a functional film (hard coat PET film) 13 to construct a pressure-sensitive adhesive functional film 14, and the film 14 is stuck to the electrode face of an ITO film 11, thereby producing a laminate of the ITO film and the hard coat PET film. In FIG. 1, the lower side of the hard coat PET film 13 is a hard coat-processed face; and the lower side of the ITO film 11 is an electrode face (ITO face). This structure can be used as a touch panel (for example, touch panel in portable telephones) or the like.

### EXAMPLES

The invention is described in more detail with reference to the following Examples, to which, however, the invention should not be limited. The monomer composition, the weight-average molecular weight and the solid concentration of the acrylic polymer (acrylic polymer solution) and the acrylic oligomer (acrylic oligomer solution) used in Examples and Comparative Example are shown in Table 1. The blend composition of the acrylic polymer, acrylic oligomer and crosslinking agent in forming the pressure-sensitive adhesive layer, and the thickness of the pressure-sensitive adhesive layer and the drying condition for the pressure-sensitive adhesive layer in Examples and Comparative Example are shown in Table 2.

### Examples of Preparation of Acrylic Polymer

### Acrylic Polymer A

A monomer ingredient of n-butyl acrylate (BA) (95 parts by weight) and acrylic acid (AA) (5 parts by weight), a polymerization initiator of 2,2′-azobisisobutyronitrile (0.2 parts by weight) and a polymerization solvent of ethyl acetate (186 parts by weight) were put into a separable flask and stirred for 1 hour with introducing nitrogen gas thereinto. Oxygen in the polymerization system was removed in that manner, and the system was heated up to 63° C. and reacted for 10 hours, and then toluene was added thereto to prepare an acrylic polymer solution having a solid concentration of 30% by weight (hereinafter this may be referred to as “acrylic polymer solution A”). In the acrylic polymer solution A, the weight-average molecular weight of the acrylic polymer (hereinafter this may be referred to as “acrylic polymer A”) was 700,000.

### Acrylic Polymers B and C

Acrylic polymer solutions were produced in the same manner as above, for which, however, the blend ratio of the monomer ingredient was changed and the amount of the polymerization solvent to be used was changed as in Table 1 (hereinafter these may be referred to as “acrylic polymer solutions B and C”). In the acrylic polymer solutions B and C, the weight-average molecular weights of the acrylic polymers (hereinafter this may be referred to as “acrylic polymers B and C”) are shown in Table 1.

The amount of the polymerization solvent used was 233 parts by weight in preparation of the acrylic polymer B and was 150 parts by weight in preparation of the acrylic polymer C.

### Examples of Preparation of Acrylic Oligomer

### Acrylic Oligomer D

A monomer ingredient of cyclohexyl methacrylate (CHMA) [the glass transition temperature of the homopolymer (polycyclohexyl methacrylate) thereof is 66° C.] (95 parts by weight) and acrylic acid (AA) (5 parts by weight), a chain transfer agent of 2-mercaptoethanol (3 parts by weight), a polymerization initiator of 2,2′-azobisisobutyronitrile (0.2 parts by weight) and a polymerization solvent of toluene (103.2 parts by weight) were put into a separable flask, and stirred for 1 hour with introducing nitrogen gas thereinto. Oxygen in the polymerization system was removed in that manner, and the system was heated up to 70° C. and reacted for 3 hours and then at 75° C. for 2 hours to prepare an acrylic oligomer solution having a solid concentration of 50% by weight (hereinafter this may be referred to as “acrylic oligomer solution D”). In the acrylic oligomer solution D, the weight-average molecular weight of the acrylic oligomer (hereinafter this may be referred to as “acrylic oligomer D”) was 4,000.

### (Acrylic Oligomer E)

A monomer ingredient of cyclohexyl methacrylate (CHMA) [the glass transition temperature of the homopolymer (polycyclohexyl methacrylate) thereof is 66° C.] (95 parts by weight) and acrylic acid (AA) (5 parts by weight), a chain transfer agent of α-methylstyrene dimer (10 parts by weight), a polymerization initiator of 2,2′-azobisisobutyronitrile (10 parts by weight) and a polymerization solvent of toluene (120 parts by weight) were put into a separable flask, and stirred for 1 hour with introducing nitrogen gas thereinto. Oxygen in the polymerization system was removed in that manner, and the system was heated up to 85° C. and reacted for 5 hours to prepare an acrylic oligomer solution having a solid concentration of 50% by weight (hereinafter this may be referred to as “acrylic oligomer solution E”). In the acrylic oligomer solution E, the weight-average molecular weight of the acrylic oligomer (hereinafter this may be referred to as “acrylic oligomer E”) was 4,300.

TABLE 1

| | | | | | Solid Concentration (% by |
|---|---|---|---|---|---|
| | | | | Weight-Average Molecular | weight) in Acrylic Polymer |
| | | Monomer | | Weight of Acrylic Polymer, | Solution, Acrylic Oligomer |
| | | Composition | | Acrylic Oligomer | Solution |
| Acrylic Polymer A | Monomer | BA | AA | 700,000 | 30 |
| (Acrylic Polymer Solution A) | Amount (part by weight) | 95 | 5 | | |
| Acrylic Polymer B | Monomer | BA | AA | 550,000 | 30 |
| (Acrylic Polymer Solution B) | Amount (part by weight) | 97 | 3 | | |
| Acrylic Polymer C | Monomer | BA | AA | 1,000,000 | 30 |
| (Acrylic Polymer Solution C) | Amount (part by weight) | 97 | 3 | | |
| Acrylic Oligomer D | Monomer | CHMA | AA | 4,000 | 50 |
| (Acrylic Oligomer Solution | Amount (part by weight) | 95 | 5 | | |
| D) | | | | | |
| Acrylic Oligomer E | Monomer | CHMA | AA | 4,300 | 50 |
| (Acrylic Oligomer Solution | Amount (part by weight) | 95 | 5 | | |
| E) | | | | | |

*The amount in the table is the amount (part by weight) of the monomer fed in preparation of the polymer or the oligomer.
The abbreviations in the table are as follows:
BA: n-butyl acrylate
AA: acrylic acid
CHMA: cyclohexyl methacrylate

### Example 1

As shown in Table 2, to the acrylic polymer solution A, added were the acrylic oligomer D in an amount of 25 parts by weight relative to 100 parts by weight of the acrylic polymer A (that is, the acrylic oligomer solution D was added in an amount of 25 parts by weight in terms of the solid content thereof), and a crosslinking agent of a polyisocyanate compound (“Coronate L” manufactured by Nippon Polyurethane Industry Co., Ltd., solid content 75% by weight) in an amount of 0.5 parts by weight in terms of the solid content thereof, thereby preparing a pressure-sensitive adhesive composition (solution).

The solution obtained in the above was cast onto the lubrication-processed surface of a polyethylene terephthalate (PET) film (thickness, 38 μm) (release liner) of which the surface had been processed for lubrication in order that the layer to be thus formed could have a dry thickness of about 25 μm, then dried under heat at 60° C. for 1 minute and then at 155° C. for 2 minutes under normal pressure, thereafter aged at 50° C. for 72 hours to produce a pressure-sensitive adhesive sheet (substrate-less double-sided pressure-sensitive adhesive sheet, having a pressure-sensitive adhesive layer thickness of 25 μm).

### Examples 2 to 4, Comparative Example 1

Pressure-sensitive adhesive compositions and pressure-sensitive adhesive sheets were produced in the same manner as in Example 1, for which, however, the type of the acrylic polymer, the type and the amount of the acrylic oligomer and the crosslinking agent, and the thickness of the pressure-sensitive adhesive layer were changed as in Table 2. In Comparative Example 1, the heating and drying condition was changed to 60° C. for 1 minute and 125° C. for 2 minutes.

In Table 2, the amount of the acrylic oligomer is in terms of the solid content of the acrylic oligomer solution (that is, the amount of the acrylic oligomer itself) (part by weight) relative to 100 parts by weight of the acrylic polymer. The amount of Coronate L is in terms of the solid content thereof (part by weight) relative to 100 parts by weight of the acrylic polymer. The amount of Tetrad C is the amount of Tetrad C itself (product itself) (part by weight) relative to 100 parts by weight of the acrylic polymer.

### EVALUATION

The pressure-sensitive adhesive compositions and the pressure-sensitive adhesive sheets (pressure-sensitive adhesive layers) produced in Examples and Comparative Example were analyzed and evaluated in terms of the extracted (meth)acrylic acid ion amount, the foaming/peeling resistance, the corrosion resistance, and the producibility (the coatability with the pressure-sensitive adhesive composition). The results of the extracted (meth)acrylic acid ion amount, the foaming/peeling resistance and the corrosion resistance are shown in Table 2.

The evaluation methods are mentioned below.

### (1) Extracted (Meth)Acrylic Acid Ion Amount:

### (Preparation of Test Piece)

From the pressure-sensitive adhesive sheet produced in Examples and Comparative Example, a test piece having a size of 10 cm width×10 cm length was cut out. The release liner was peeled off, and a PET film ('“Lumirror S10” manufactured by Toray Industries, Inc., having a thickness of 25 μm) was stuck to one surface of the test piece and only the other pressure-sensitive adhesive surface of the test piece was kept exposed (exposed area of the pressure-sensitive adhesive surface, 100 cm²).

### (Boiling Extraction of (Meth)Acrylic Acid Ion)

Next, the test piece was put into pure water (50 ml) at a temperature of 100° C. and boiled therein for 45 minutes for boiling extraction to prepare an extract.

Next, the total amount (unit, ng) of the acrylic acid ion and the methacrylic acid ion in the extract obtained in the above was measured in accordance with ion chromatography, and the total amount (unit, ng/cm²) of the acrylic acid ion and the methacrylic acid ion per the unit area of the pressure-sensitive adhesive surface (exposed pressure-sensitive adhesive face) of the test piece was computed.

### (Conditions of Ion Chromatography)

| | |
|---|---|
| Analysis Device: | DIONEX's DX-320 |
| Separation Column: | Ion Pac AS15 (4 mm × 250 mm) |
| Guard Column: | Ion Pac AG15 (4 mm × 50 mm) |
| Removal System: | ASRS-ULTRA (external mode, 100 mA) |
| Detector: | Electroconductivity detector |
| Eluent: | 7 mM KOH (0 to 20 minutes) |
| | 45 mM KOH (20 to 30 minutes) |
| | (An eluent generator EG40 was used.) |
| Eluent Flow Rate: | 1.0 ml/min |
| Injected Sample | 250 μl |
| Amount: | |

In Examples 1 to 4 and Comparative Example 1, only acrylic acid ion was detected.

### (2) Foaming/Peeling Resistance:

One pressure-sensitive adhesive face of the pressure-sensitive adhesive sheet produced in Examples and Comparative Example was stuck to a PET film (‘“A4300” manufactured by Toyobo Co., Ltd., having a thickness of 125 μm), to prepare a film piece having a size of 100 mm width×100 mm length.

The release liner was peeled off from the film piece, and the film piece was stuck to a polycarbonate (PC) sheet (“Panlite Sheet PC1111” manufactured by Teijin Chemicals Ltd., having a thickness of 1 mm) and fixed thereto, thereby preparing a sample piece having a layer constitution of PET film/pressure-sensitive adhesive layer (pressure-sensitive adhesive sheet)/PC sheet.

The sample piece was heat-treated in an oven at 80° C. for 5 hours (heat resistance test). After the heat resistance test, the adhesion interface (interface between the pressure-sensitive adhesive layer and the PC sheet) of the sample piece was visually checked. The samples with neither foaming nor swelling were evaluated as “good” in point of the foaming/peeling resistance thereof, and those with some foaming or swelling, even though slight, were evaluated as “poor” in point of the foaming/peeling resistance thereof.

### (3) Corrosion Resistance:

A PET film (“Lumirror S-10 #25” manufactured by Toray Industries, Inc., having a thickness of 25 μm) was stuck to one surface of the pressure-sensitive adhesive sheet produced in Examples and Comparative Example, and cut into test pieces each having a size of 20 mm width×50 mm length.

As shown in FIG. 2, a silver paste was applied onto the both sides in a width of 15 mm of an electroconductive PET film (“Elecrysta P400L-TNMP” manufactured by Nitto Denko Corporation) (size, 70 mm length×25 mm width), and the pressure-sensitive adhesive face of the test piece 21 from which the release liner had been peeled away was stuck to the electroconductive face (on the side of the ITO film-coated face 22) of the PET film. This was left in an environment at 23° C. for 24 hours, and then left in an environment at 60° C. and 95% RH for 250 hours and another environment at 80° C. for 250 hours. The ratio (%) of “resistance value after left at 60° C. and 95% RH for 250 hours” to “resistance value just after sticking” [=(resistance value after left at 60° C. and 95% RH for 250 hours)/(resistance value just after sticking)×100(%)]; and the ratio (%) of “resistance value after left at 80° C. for 250 hours” to “resistance value just after sticking” [=(resistance value after left at 80° C. for 250 hours)/(resistance value just after sticking)×100(%)] were computed. An electrode was attached to the silver paste part 23 in both sides of the sample, and the resistance value was measured with “3540 Milliohm Hitester” manufactured by Hioki E. E. Corporation.

The samples of which both the ratio of “resistance value after left at 60° C. and 95% RH for 250 hours” to “resistance value just after sticking” and the ratio of “resistance value after left at 80° C. for 250 hours” to “resistance value just after sticking” were less than 120% were evaluated as “good” in point of the corrosion resistance thereof, and those of which at least any one of the two was 120% or more were evaluated as “poor” in point of the corrosion resistance thereof.

As a blank, the electroconductive PET film with no pressure-sensitive adhesive sheet stuck thereto was tested in the same manner as above, and as a result, the ratio of the “resistance value after left for 250 hours” to the “resistance value just after sticking” of the blank sample was 110% under the condition of 80° C., and was 120% under the condition of 60° C. and 95% RH.

(4) Producibility (Coatability with Pressure-Sensitive Adhesive Composition):

The pressure-sensitive adhesive composition (solution) produced in Examples and Comparative Example was cast onto a lubrication-processed PET film (release liner) at a coating speed of 5 to 20 m/min to produce a pressure-sensitive adhesive sheet. In this process, when the coated surface was smooth having no coating seam, the samples were evaluated as “good” in point of the producibility (coatability with the pressure-sensitive adhesive composition; and when the coated surface was not smooth having some coating seams, the samples were evaluated as “poor” in point of the producibility (coatability with the pressure-sensitive adhesive composition). The coated samples were checked visually.

TABLE 2

| | | | | | | | Comparative |
|---|---|---|---|---|---|---|---|
| | | | Example 1 | Example 2 | Example 3 | Example 4 | Example 1 |
| Pressure- | Acrylic Polymer | type | Acrylic | Acrylic | Acrylic | Acrylic | Acrylic |
| Sensitive | | | Polymer A | Polymer B | Polymer B | Polymer C | Polymer A |
| Adhesive | | amount (wt. pt.) | 100 | 100 | 100 | 100 | 100 |
| Layer | Acrylic Oligomer | type | Acrylic | Acrylic | Acrylic | Acrylic | Acrylic |
| | | | Oligomer D | Oligomer E | Oligomer E | Oligomer D | Oligomer D |
| | | amount (wt. pt.) | 25 | 25 | 25 | 25 | 25 |
| | Crosslinking Agent | type | Coronate L | Tetrad C | Tetrad C | Tetrad C | Tetrad C |
| | | amount (wt. pt.) | 0.5 | 0.075 | 0.075 | 0.035 | 0.075 |
| | Thickness of | (μm) | 25 | 25 | 12 | 25 | 25 |
| | Pressure- | | | | | | |
| | Sensitive | | | | | | |
| | Adhesive Layer | | | | | | |
| | Drying Condition | | 60° C. 1 min + | 80° C. 1 min + | 60° C. 1 min + | 60° C. 1 min + | 60° C. 1 min + |
| | | | 155° C. 2 min | 155° C. 2 min | 155° C. 2 min | 155° C. 2 min | 125° C. 2 min |
| | Extracted | (ng/cm²) | 15 | 10 | 7 | 10 | 48 |
| | (meth)acrylic acid | | | | | | |
| | ion amount | | | | | | |

| | | | | | |
|---|---|---|---|---|---|
| Foaming/peeling Resistance | good | good | good | good | good |
| Corrosion Resistance | good | good | good | good | poor |

Coronate L: “Coronate L” (isocyanate-type crosslinking agent), manufactured by Nippon Polyurethane Industry Co., Ltd.
Tetrad C: “Tetrad C” (epoxy-type crosslinking agent), manufactured by Mitsubishi Gas Chemical Company, Inc.

As is obvious from the results in Table 2, the pressure-sensitive adhesive sheets of the invention (Examples) had excellent corrosion resistance to metal thin film. In addition, they were excellent also in foaming/peeling resistance. On the other hand, in case where the extracted (meth)acrylic acid ion amount was too much (Comparative Example), the corrosion resistance of the pressure-sensitive adhesive sheet to metal thin film was poor.

The pressure-sensitive adhesive compositions in which the weight-average molecular weight of the acrylic polymer fell within a range of from 500,000 to 900,000 (Examples 1 to 3 and Comparative Example 1) were excellent in the coatability (producibility) therewith not forming coating seams at a coating speed of from 5 to 20 m/min. On the other hand, the pressure-sensitive adhesive composition in which the weight-average molecular weight of the acrylic polymer was too large (Example 4) formed coating seams at a coating speed of 20 in/min, and the coatability (producibility) with it was poor, and the pressure-sensitive adhesive composition was not suitable to high-speed production.

While the present invention has been described in detail and with reference to specific embodiments thereof, it will be apparent to one skilled in the art that various changes and modifications can be made therein without departing from the scope thereof.

This application is based on Japanese patent application No. 2009-043078 filed Feb. 25, 2009, the entire contents thereof being hereby incorporated by reference.

What is claimed is:

1. A pressure-sensitive adhesive sheet comprising at least one pressure-sensitive adhesive layer formed of a pressure-sensitive adhesive composition containing an acrylic polymer (a) in which the total content of acrylic acid and methacrylic acid relative to the entire monomer ingredients constituting the acrylic polymer is 10% by weight or less, wherein the total amount of an acrylic acid ion and a methacrylic acid ion extracted from the pressure-sensitive adhesive sheet with pure water under the condition of 100° C. for 45 minutes, as measured in accordance with an ion chromatography, is 20 ng/cm² or less per the unit area of the pressure-sensitive adhesive layer.

2. The pressure-sensitive adhesive sheet according to claim 1, wherein the pressure-sensitive adhesive composition contains the following acrylic oligomer (b) in an amount of from 10 to 35 parts by weight relative to 100 parts by weight of the following acrylic polymer (a),
the acrylic polymer (a) being an acrylic polymer comprising an alkyl (meth)acrylate in which the alkyl group has from 4 to 12 carbon atoms, and/or an alkoxyalkyl(meth)acrylate as the main monomer ingredient, and acrylic acid and/or methacrylic acid as an indispensable monomer ingredient, in which the total content of the acrylic acid and the methacrylic acid relative to the entire monomer ingredients constituting the acrylic polymer is from 2.5 to 10% by weight, the acrylic polymer (a) having a weight-average molecular weight of from 500,000 to 900,000, and
the acrylic oligomer (b) being an acrylic oligomer comprising a (meth)acrylate which has a cyclic structure in the molecule thereof and of which the homopolymer has a glass transition temperature of from 60 to 190° C., as the main monomer ingredient, and acrylic acid and/or methacrylic acid as an indispensable monomer ingredient, in which the total content of the acrylic acid and the methacrylic acid relative to the entire monomer ingredients constituting the acrylic oligomer is from 2.5 to 10% by weight, the acrylic oligomer (b) having a weight-average molecular weight of 3,000 or more but less than 6,000.

3. The pressure-sensitive adhesive sheet according to claim 2, wherein the acrylic polymer (a) and the acrylic oligomer (b) respectively are an acrylic polymer and an acrylic oligomer prepared in accordance with a solution polymerization method or an emulsion polymerization method.

4. The pressure-sensitive adhesive sheet according to claim 2,
wherein the acrylic polymer (a) is an acrylic polymer comprising the acrylic acid as an indispensable monomer ingredient, in which the content of the acrylic acid relative to the entire monomer ingredients constituting the acrylic polymer is from 2.5 to 10% by weight,
wherein the acrylic oligomer (b) is an acrylic oligomer comprising the acrylic acid as an indispensable monomer ingredient, in which the content of the acrylic acid relative to the entire monomer ingredient constituting the acrylic oligomer is from 2.5 to 10% by weight, and
wherein the amount of the acrylic acid ion extracted from the pressure-sensitive adhesive sheet with pure water at 100° C. for 45 minutes, as measured in accordance with an ion chromatography, is 20 ng/cm² or less per the unit area of the pressure-sensitive adhesive layer.

5. The pressure-sensitive adhesive sheet according to claim 1, which is a substrate-less pressure-sensitive adhesive sheet having no substrate.

6. The pressure-sensitive adhesive sheet according to claim 1, which is for use in an application of being stuck to a metal thin film or a metal oxide thin film.

7. The pressure-sensitive adhesive sheet according to claim 1, which is a pressure-sensitive adhesive sheet for touch panel for use in a production of a touch panel.

8. A pressure-sensitive adhesive functional film comprising a functional film and the double-sided pressure-sensitive adhesive sheet according to claim 1 laminated on at least one surface of the functional film, the pressure-sensitive adhesive sheet being a double-sided pressure-sensitive adhesive sheet.
